(19) United States
(12) Patent Application Publication
(10) Pub. No.: US 2017/0355620 A1
(43) Pub. Date: Dec. 14, 2017

(54) METHOD OF FILTERING WASTE WATER

(71) Applicant: NEXUS EWATER PTY LTD, Fyshwick (AU)

(72) Inventors: Tom Wood, Fyshwick (AU); Andrew Hermann, Fyshwick (AU)

(73) Assignee: NEXUS EWATER PTY LTD, Fyshwick (AU)

(21) Appl. No.: 15/516,231

(22) PCT Filed: Sep. 29, 2015
(86) PCT No.: PCT/AU2015/050581

§ 371 Date: Mar. 31, 2017

(30) Foreign Application Priority Data
Oct. 1, 2014 (AU) 2014903912

(51) Int. Cl. C02F 1/28; C02F 1/00; C02F 1/32

(52) U.S. Cl. CPC C02F 1/283; C02F 1/325; C02F 1/001; C02F 2209/40; C02F 2303/04; C02F 2301/024; C02F 2209/006

(57) ABSTRACT

A filtration system (10) includes a filter (12) comprising a receptacle defining a chamber and a granular filtering medium contained in the chamber of the receptacle, the receptacle further defining an opening (22). An injection pump (26) is in communication with the opening (22) for injecting waste water to be treated into the chamber of the receptacle, the injection pump (26) being configured to pump the water into the chamber of the receptacle at a first flow rate. A discharge pump (32) is also in communication with the opening (22) for discharging water from the chamber of the receptacle, the discharge pump (32) being configured to discharge the water from the chamber of the receptacle at a second flow rate which is lower than the first flow rate of the injection pump (26).

### CROSS-REFERENCE TO RELATED APPLICATIONS

The present application claims priority from Australian Provisional Patent Application No 2014903912 filed on 1 Oct. 2014, the contents of which are incorporated herein by reference.

### TECHNICAL FIELD

This disclosure relates, generally, to a filtration system and, more particularly but not necessarily exclusively, to a method of filtering waste water and to a filtration system for use in the treatment of waste water.

### BACKGROUND

Large scale waste water treatment plants run trickling systems, aerated, continuous processes and/or mechanical mixing with daily backwashing to optimise performance of granular filters used in the treatment plant. Such systems are voluminous and are expensive to run. As such, they are not appropriate for smaller scale plants such as those which may be used in domestic applications or small industry applications.

In other waste water treatment applications, once the treated water has passed through the granular filter, it undergoes further purification treatment by additional components of the system. Waste water which has been inadequately treated in the granular filter or which carries contaminants out of the granular filter places an increased load on those additional components resulting in overall poorer purification results.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In a first aspect, there is provided a method of filtering waste water using a filter of the type comprising a receptacle defining a chamber and a granular filtering medium contained in the chamber of the receptacle, the method including

injecting waste water to be treated at a first flow rate into the chamber of the receptacle to cause the waste water to be driven into contact with the filtering medium;

retaining the waste water in the chamber in contact with the filtering medium for a specified dwell time; and

discharging water from the chamber at a second flow rate which is lower than the first flow rate.

The method may include injecting the waste water at a first flow rate in the range of about 20 L/min to 50 L/min. The method may include selecting the first flow rate to be about 40 L/min. It will be appreciated that the first flow rate could be in any range from about 20 L/min-30 L/min, 30 L/min-40 L/min and 40 L/min-50 L/min.

The method may include selecting the specified dwell time to be in the range from about 5 minutes to about 60 minutes. The method may include selecting the specified dwell time to be about 30 minutes. It will be appreciated that the specified dwell time may fall within any of a desired number of ranges of about 5-10 minutes, 10-15 minutes, 15-20 minutes, 20-25 minutes, 25-30 minutes, 30-35 minutes, 35-40 minutes, 40-45 minutes, 45-50 minutes, 50-55 minutes and 55-60 minutes depending on the batch process in use.

The method may include discharging the water from the chamber of the receptacle at a second flow rate of about 1 L/min-10 L/min. The method may include selecting the second flow rate to be about 2 L/min. It will be appreciated that the second flow rate could be in any range from about 1 L/min-3 L/min, 3 L/min-5 L/min, 5 L/min-7 L/min and 7 L/min-10 L/min.

Further, the method may include discharging the water in a pulsed manner with a specified duty cycle. The term “duty cycle” is to be understood as the time during which a discharge pump being used to discharge the water is operative relative to the time the discharge pump is inoperative during the discharging process.

The duty cycle may have a range of about 4:1 to about 1:4 and, more particularly, may be at least one of an approximately 2:1 duty cycle, an approximately 1:1 duty cycle and any duty cycle in between.

The receptacle may define an opening via which the waste water is injected into the chamber of the receptacle and the method may include injecting the waste water and discharging the water through the same opening.

The method may include imparting turbulence to the waste water as it is injected into the filtering medium contained in the chamber of the receptacle. The creation of turbulence breaks down boundary layers and improves contact between the waste water and the filtering medium.

The method may include subjecting the water discharged from the filter to further treatment, including at least partial sterilisation, downstream of the filter and storing treated water, the method further including using a quantity of the stored, treated water to flush components used at least in the further treatment of the waste water. The further treatment may involve particle filtration followed by at least partial sterilisation and the method may include using a pulse of treated water to flush a particle filtration module and a sterilisation module used in the further treatment of the water.

In a second aspect, there is provided a method of filtering waste water using a filter of the type comprising a receptacle defining a chamber and a granular filtering medium contained in the chamber of the receptacle, the method including

injecting waste water to be treated into the chamber of the receptacle to cause the waste water to be driven into contact with the filtering medium;

retaining the waste water in the chamber in contact with the filtering medium for a specified dwell time; and

discharging water from the chamber in a pulsed manner with a specified duty cycle.

In a third aspect, there is provided a filtration system which includes

a filter comprising a receptacle defining a chamber and a granular filtering medium contained in the chamber of the receptacle, the receptacle further defining an opening;

an injection pump in communication with the opening for injecting waste water to be treated into the chamber of the receptacle, the injection pump being configured to pump the water into the chamber of the receptacle at a first flow rate; and

a discharge pump also in communication with the opening for discharging water from the chamber of the receptacle, the discharge pump being configured to discharge the water from the chamber of the receptacle at a second flow rate which is lower than the first flow rate of the injection pump.

The system may include a controller for controlling operation of at least the discharge pump to cause the discharge pump to discharge the water from the receptacle in a pulsed manner with a specified duty cycle.

The system may include a turbulence enhancing mechanism arranged downstream of the opening of the receptacle to impart turbulence to the waste water as it is injected into the chamber of the receptacle.

Further, the system may include an isolation valve arranged upstream of the opening to inhibit back flow of water discharged via the discharge pump into the injection pump or any components arranged upstream of the injection pump.

The system may include additional purification components arranged downstream of the filter and a storage unit for storing further treated water output from the additional purification components, the system further including a feedback mechanism for feeding a quantity of water stored in the storage unit to flush at least the additional purification components. The additional purification components may comprise a particle filtration module arranged downstream of the filter and a sterilisation module arranged downstream of the particle filtration module, the feedback mechanism flushing at least those modules.

The feedback mechanism may be configured to use a pulse of treated water stored in the storage unit to flush the particle filtration module and the sterilisation module.

In a fourth aspect, there is provided a filtration system which includes

a filter comprising a receptacle defining a chamber and a granular filtering medium contained in the chamber of the receptacle and the receptacle further defining an opening;

an injection pump in communication with the opening for injecting waste water to be treated into the chamber of the receptacle;

a discharge pump also in communication with the opening for discharging water from the chamber of the receptacle; and

a controller for controlling operation of at least the discharge pump to cause the discharge pump to discharge water from the receptacle in a pulsed manner with a specified duty cycle.

### BRIEF DESCRIPTION OF DRAWINGS

Embodiments of the disclosure are now described by way of example with reference to the accompanying drawings in which:—

FIG. 1 shows a schematic block diagram of an embodiment of a filtration system;

FIG. 2 shows a flow chart of an embodiment of a method of filtering waste water;

FIG. 3 shows a perspective view of an embodiment of a filter for use with the system of FIG. 1;

FIG. 4 shows a plan view of the filter of FIG. 3; and

FIG. 5 shows a sectional side view of the filter of FIG. 3 taken along line V-V in FIG. 4 of the drawings.

### DETAILED DESCRIPTION OF EXEMPLARY EMBODIMENTS

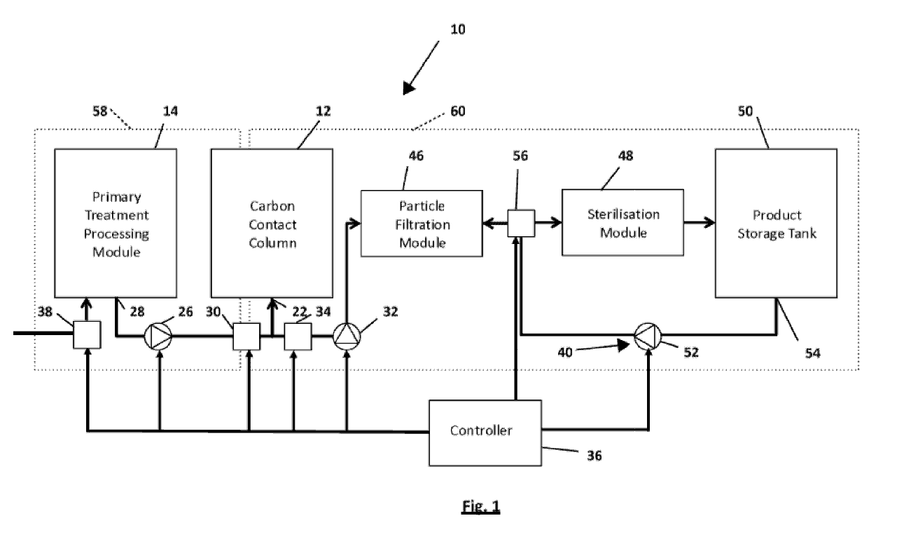

Referring initially to FIG. 1 of the drawings, an embodiment of a filtration system is illustrated and is designated generally by the reference numeral 10. The system 10 is intended particularly for use in the treatment of waste water. The term “waste water” is to be understood as covering both grey water and sewage. While the system 10 is intended particularly for use in the treatment of grey water, the system 10 can also treat waste water which includes sewage.

The system 10 comprises a filter 12 arranged downstream of a primary treatment processing module 14. The primary treatment processing module 14 is a bubble separator for removing surfactants from the waste water as described, for example, in greater detail in our co-pending International Patent Application No. PCT/AU2015/050513 dated 1 Sep. 2015 and entitled “Apparatus for treating water”. The disclosure of the '513 application deals with an improvement to the Applicant's system as described in International Patent Publication No. WO/2011/160185 filed on 24 Jun. 2011 and entitled “A process and apparatus for purifying water”.

As described in WO/2011/160185, the bubble separator separates bubbles and entrained contaminants from aerated waste water. The disclosure of PCT/AU2015/050513 describes an improvement in effecting separation of the surfactants from the waste water. To the extent permitted by the applicable national law, both applications are incorporated herein by reference in their entirety.

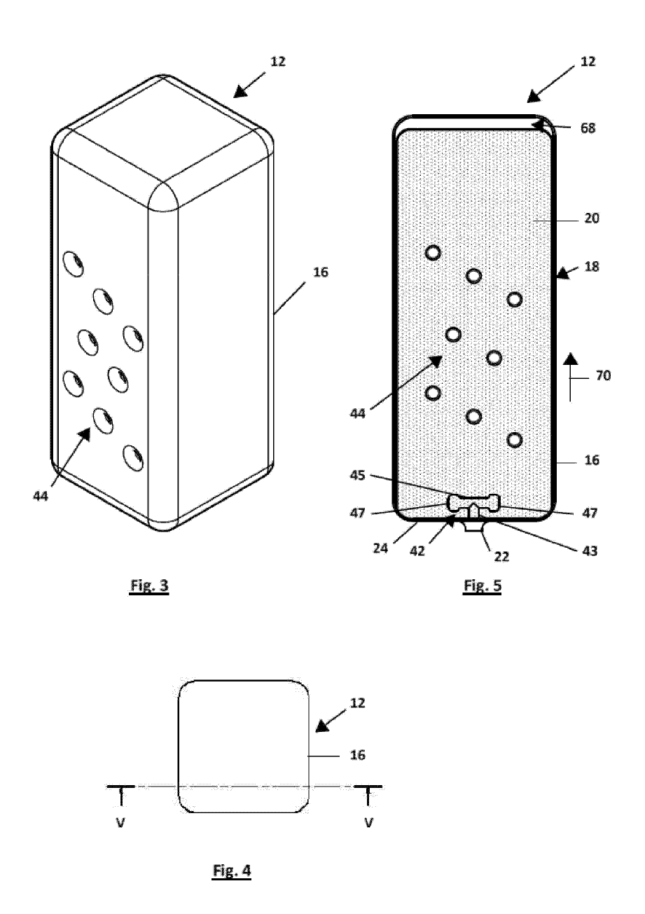

As shown in greater detail in FIGS. 3-5 of the drawings, the filter 12 comprises a receptacle 16 defining a chamber 18. The filter 12 is a carbon contact filter, also known as a “carbon contact column”. The chamber 18 of the receptacle 16 therefore contains a granular filtering medium in the form of activated carbon 20.

An opening 22 is defined in a base or floor 24 of the receptacle 16 of the filter 12. Waste water to be treated in the filter 12 is injected into the chamber 18 of the receptacle 16 via the opening 22. The opening 22 is also used to discharge filtered, or treated, water from the chamber 18 of the receptacle 16 for further processing, as will be described in greater detail below.

The filtration system 10 includes an injection pump 26 connected to an outlet 28 of the primary treatment processing module 14. The injection pump 26 pumps waste water treated in the primary treatment processing module 14 via an isolation, or one-way, valve 30 via the opening 22 into the chamber 18 of the receptacle 16 of the filter 12 to come into contact with the activated carbon 20 of the filter 12.

The injection pump 26 is configured to pump the water into the chamber 18 of the receptacle 16 at a first flow rate. This first flow rate is typically in a range from about 20 L/min to about 50 L/min and, depending on the capacity of the primary treatment processing module 14 and other factors, is about 40 L/min. The filtration system 10 is a batch process system so that, while one batch of waste water is being treated in the primary treatment processing module 14, a preceding batch is being filtered in the filter 12. Thus, the rate at which the treated waste water is charged from the module 14 into the filter 12 depends on, amongst other factors, the capacity of the primary treatment processing module 14.

The filtration system 10 further includes a discharge pump 32 in communication with the opening 22 of the receptacle 16 of the filter 12 via a valve 34. The discharge pump 32 effects discharge of filtered, or treated, water from the chamber 18 of the receptacle 16.

The discharge pump 32 is configured to discharge the treated water from the chamber 18 of the receptacle 16 at a second flow rate which is lower than the first flow rate of the injection pump 26. This second flow rate of the discharge pump 32 is, typically, in a range from about 1 L/min to about 10 L/min and, in an embodiment, is about 2 L/min.

Further, the discharge pump 32 is configured to operate in a pulsed manner discharging the treated water from the chamber 18 of the receptacle 16 in pulses with a specified duty cycle. The duty cycle has a range of about 4:1 to about 1:4 and, more particularly, is, for example, about a 2:1 or about a 1:1 duty cycle or any duty cycle between these two values.

Thus, the system 10 includes a controller 36 which controls, inter-alia, operation of the discharge pump 32 to cause it to operate in the pulsed manner. It is noted that the controller 36 further controls operation of the injection pump 26, the valves 30 and 34, a further valve or pump 38 which controls ingress of waste water into the primary treatment processing module 14 and also controls a feedback mechanism 40, as will be described in greater detail below.

The filter 12 further includes a turbulence enhancing mechanism 42 (FIG. 5) arranged in the chamber 18 of the receptacle 16, downstream of the opening 22 of the receptacle 16. The filter 12 also includes a disruptor mechanism, in the form of a series of spaces baffles 44, arranged across the chamber 18 of the receptacle 16. The turbulence enhancing mechanism 42 serves to impart turbulence to the water as it is injected by means of the injection pump 26 into the chamber 18 of the receptacle 16 to improve contact between the water and the activated carbon 20. The turbulence enhancing mechanism 42 also assists in inhibiting the formation of “channels” in the activated carbon 20, particularly as the filtered water is being discharged from the chamber 18 of the receptacle 16 under the action of the discharge pump 32.

The turbulence enhancing mechanism 42 comprises a porting arrangement in the form of a T-piece. A stem 43 of the porting arrangement is in communication with the opening 22 of the receptacle 16. A cross-piece 45 of the porting arrangement defines a pair of oppositely directed ports 47. It will be appreciated that, in other embodiments, the ports 47 of the porting arrangement could face towards each other, parallel to each other (whether facing the same way or in opposite directions) or pointing at different elevations.

Each port 47 is semi-occluded both to encourage turbulent flow of the waste water as it is injected into the chamber 18 of the receptacle 16 but also to inhibit the escape of activated carbon 20 through the opening 22 of the receptacle 12 when filtered water is discharged through the opening 22 of the receptacle 12. In an embodiment, each port 47 is semi-occluded by having radially extending vanes (not shown) mounted in the port 47.

The baffles 44 also serve to impart turbulence to the injected water to enhance contact between the water and the activated carbon 20 and to inhibit the formation of channels in the activated carbon 20. Such channels can reduce the degree of contact between the water to be filtered and the activated carbon and are therefore undesirable.

The turbulence enhancing mechanism 42 and the baffles 44 are described in greater detail in our co-pending International Patent Application entitled “A filtration system”, claiming priority from Australian Provisional Patent Application No. 2014903913 dated 1 Oct. 2014, and filed on the same day as the present application. The contents of the co-pending International Patent Application referenced in this paragraph are incorporated herein by reference in its entirety, to the extent permitted by the applicable national law.

The filtration system 10 includes additional, or secondary, purification components arranged downstream of the filter 12. These secondary purification components include a particle filtration module 46, in the form of a pleated filter, and a sterilisation module 48, in the form of an ultraviolet light unit (UV unit), arranged downstream of the particle filtration module 46.

The filtration system 10 also includes a storage unit, in the form of a storage tank, 50 into which treated water output from the UV unit of the sterilisation module 48 is charged for subsequent re-use.

The feedback mechanism 40 of the system 10 comprises a pump 52 connected to an outlet 54 of the storage tank 50 and a three way valve 56 interposed between the particle filtration module 46 and the sterilisation module 48.

The feedback mechanism 40 is used for flushing the particle filtration module 46 and the sterilisation module 48. A pulse of stored, treated water is, periodically, extracted from the storage tank 50 via the pump 52 under the action of the controller 36 to be fed into the particle filtration module 46 and the sterilisation module 48 via the valve 56 to flush the modules 46 and 48. A portion of the pulse of water may be driven through the particle filtration module 46 and used also to flush the discharge pump 32 as well as any lines between the opening 22 of the receptacle 16 of the filter 12 and the storage tank 50.

It is to be noted that the water output from the primary treatment processing module 14 contains quantities of biologically active material such as bacteria. These bacteria interact with the activated carbon 20 in the receptacle 16 further to purify the water in the carbon filter 12. The bacteria are aerobic bacteria and, as such, do not generate unpleasant odours. However, if the activated carbon 20 of the filter 12 dries out or the bacteria consume all the oxygen in the filter 12, the bacteria begin to convert to anaerobic bacteria resulting in malodorous conditions. This affects the carbon filter 12 as well as components downstream of the carbon filter 12. It can also adversely affect subsequent batches of water injected into the carbon filter 12.

By ensuring that the activated carbon 20 of the filter 12 is consistently aerated and maintained in a moist condition, the likelihood of malodorous conditions occurring is reduced. Further, the periodic flushing of components downstream of the filter 12 using a pulse of water from the storage tank 50 further reduces the chances of malodorous conditions arising.

It is to be noted that the isolation valve 30 effectively separates the system 10 into two parts being, firstly, a zone of biologically active water 58 and, secondly, a zone of substantially purified water 60.

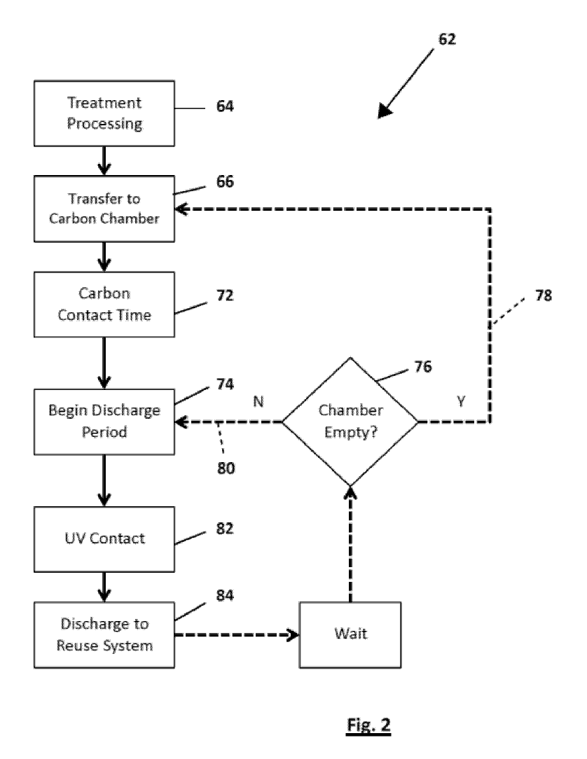

Referring now to FIG. 2 of the drawings, a flow chart of an embodiment of a method of filtering waste water is shown in greater detail and is designated generally by reference numeral 62. At step 64, treatment of the waste water commences by charging a batch of waste water into the bubble separator of the primary treatment processing module 14 via the inlet valve or pump 38 under the action of the controller 36.

Processing of the waste water in the module 14 involves aerating the waste water using a venturi (not shown) prior to injecting the water into the bubble separator. In the bubble separator, surfactants are separated from the water. The water from which the surfactants have been separated is drawn from the module 14 through the outlet 28 via the injection pump 26 under the action of the controller 36, through the isolation valve 30 and into the chamber 18 of the receptacle 16 of the filter 12 as shown at step 66.

As described above, the water is injected into the carbon filter 12 at a flow rate of about 40 L/min. This encourages turbulent flow in the water as it is injected into the filter 12 to enhance contact with the activated carbon 20 of the filter 12. The turbulent flow is further enhanced due to the use of the turbulence enhancing mechanism 42 and the baffles 44.

The activated carbon 20, when moist, has a tendency to clump and contract so that a gap 68 (FIG. 5) forms at the top of the activated carbon 20. When the water is injected into the chamber 18 of the receptacle 16, if the baffles 44 were omitted, there may be a tendency for the body of activated carbon 22 to remain adhering together to move as one body, in a piston-like manner. Thus, the entire body of activated carbon 20 could be displaced in the direction of arrow 70 to close the gap 68 under the effect of the injected water with the water collecting below the carbon and reducing the contact area between the water and the carbon 20. The baffles 44 serve to obviate this problem by inhibiting clumping of the body of activated carbon 20.

Once the water has been injected into the chamber 18 of the receptacle 16, the valves 30 and 34 are both closed under the action of the controller 36 effectively closing the opening 22 of the receptacle 16. As shown at step 72, the water is retained within the carbon 20 for a predetermined dwell time.

The dwell time is selected based on numerous factors including the size of the batch of water being treated, the extent of contamination of the water and, hence, the time to be spent in the primary treatment processing module 14, or the like. The dwell time is selected to be in the range from about 5 minutes to about 60 minutes and, in an embodiment, is about 30 minutes.

After expiry of the dwell time period, the controller 36 opens the valve 34 to begin discharge of the filtered water from the filter 12 as shown at step 74 in FIG. 2. The controller 36 controls the discharge pump 32 to discharge the filtered water from the receptacle 16 of the filter 12 in a pulsed manner. The pump 32 extracts water from the receptacle at a rate of approximately 2 L/min. with the specified duty cycle.

The benefit of pulsing the water as it is extracted is that greater contact time with the activated carbon 20 occurs. Also, there is less likelihood of the draining water forming channels in the body of activated carbon 20. As indicated above, if channels were to form in the activated carbon 20, contact between the water to be treated and the activated carbon 20 may be reduced resulting in a reduced filtering efficiency of the filter 12.

Further, causing the water to be discharged in a pulsed, slow manner from the filter 12 facilitates retaining the activated carbon 20 in a moist condition and reduces the likelihood of it drying out completely. This minimises the risk of aerobic bacteria converting to anaerobic bacteria with the consequential malodorous conditions arising.

After completion of discharge, the controller 36 determines whether or not the chamber 18 of the receptacle 16 is empty as shown at 76. If the controller 36 determines that the chamber 18 is empty, it causes a further batch of treated water from the primary treatment processing module 14 to be charged into the filter 12 for filtering by the filter 12 as shown at 78. If the controller 36 determines that the chamber 18 is not empty, it commences or continues with the discharge procedure as shown at 80.

A batch of water output from the filter 12 is fed through the pleated filter of the particle filtration module 46 where additional filtering of particles entrained in the water occurs. The water output from the module 46 is then fed through the valve 56 into the sterilisation module 48 as shown at step 82. In the sterilisation module 48, the water is exposed to ultraviolet light via the UV unit of the module 48 to undergo at least partial sterilisation.

Treated water is charged from the sterilisation module 48 into the storage tank 50 as shown at 84.

Another advantage of pulsing water out of the carbon filter 12 is that the UV unit of the sterilisation module 48 can be retained in an energised state. The lifespan of such a UV unit is reduced by continuously cycling it on and off. Further, retaining the UV unit energised also reduces the lifespan of the UV unit since it is likely to overheat. Pulsing water from the carbon filter 12 through the UV unit keeps the unit cool while maintaining it energised. This has the overall effect of extending the lifespan of the UV unit of the sterilisation module 48 and reduces maintenance costs of the system 10.

In addition, the aerobic biological activity within the carbon filter 12 increases its performance generally and maintaining the activated carbon 20 in a moist condition extends the lifespan of the carbon filter 12. The applicant has found that the lifespan of the carbon filter can be extended by between 10 and 50 times if the activated carbon 20 of the filter 12 is exposed to biological activity and retained in a moist condition.

It will be appreciated that the filtration system 10 is intended to be used in a domestic dwelling or small premises where maintenance of the system should be kept as low as possible. Ideally, the system 10 should operate in an almost “set-and-forget” manner. By extending the operating life of the carbon filter 12, the pleated filter of the particle filtration module 46 and the UV unit of the sterilisation module 48, the need for maintenance of the system 10 is significantly reduced. This, therefore, benefits an operator of the system 10 in that the operator need pay less attention to maintaining the system than would otherwise be the case.

It is a further advantage of the disclosure that a method of operating a filter 12 and filtration system 10 are provided which improves the filtering efficiency of the filter 12 and the system 10 thereby improving the overall purification of waste water treated in the system 10. The likelihood of malodorous conditions arising are also greatly reduced and the risk of contaminating subsequent batches of water to be treated is also significantly reduced.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of filtering waste water using a filter of the type comprising a receptacle defining a chamber and a granular filtering medium contained in the chamber of the receptacle, the method including
injecting waste water to be treated at a first flow rate into the chamber of the receptacle to cause the waste water to be driven into contact with the filtering medium;
retaining the waste water in the chamber in contact with the filtering medium for a specified dwell time; and
discharging water from the chamber at a second flow rate which is lower than the first flow rate.

2. The method of claim 1 which includes injecting the waste water at a first flow rate in the range of about 20 L/min to 50 L/min.

3. The method of claim 2 which includes selecting the first flow rate to be about 40 L/min.

4. The method of claim 1 which includes selecting the specified dwell time to be in the range from about 5 minutes to about 60 minutes.

5. The method of claim 4 which includes selecting the specified dwell time to be about 30 minutes.

6. The method of claim 1 which includes discharging the water from the chamber of the receptacle at a second flow rate of about 1 L/min-10 L/min.

7. The method of claim 6 which includes selecting the second flow rate to be about 2 L/min.

8. The method of claim 1 which includes discharging the water in a pulsed manner with a specified duty cycle.

9. The method of claim 8 in which the duty cycle has a range of about 4:1 to about 1:4.

10. The method of claim 10 in which the duty cycle is at least one of an approximately 2:1 duty cycle, an approximately 1:1 duty cycle and any duty cycle in between.

11. The method of claim 1 in which the receptacle defines an opening via which the waste water is injected into the chamber of the receptacle and in which the method includes injecting the waste water and discharging the water through the same opening.

12. The method of claim 1 which includes imparting turbulence to the waste water as it is injected into the filtering medium contained in the chamber of the receptacle.

13. The method of claim 1 which includes subjecting the water discharged from the filter to further treatment, including at least partial sterilisation, downstream of the filter and storing treated water, the method further including using a quantity of the stored, treated water to flush components used at least in the further treatment of the waste water.

14. The method of claim 13 in which the further treatment involves particle filtration followed by at least partial sterilisation and in which the method includes using a pulse of treated water to flush a particle filtration module and a sterilisation module used in the further treatment of the waste water.

15. A method of filtering waste water using a filter of the type comprising a receptacle defining a chamber and a granular filtering medium contained in the chamber of the receptacle, the method including
injecting waste water to be treated into the chamber of the receptacle to cause the waste water to be driven into contact with the filtering medium;
retaining the waste water in the chamber in contact with the filtering medium for a specified dwell time; and
discharging water from the chamber in a pulsed manner with a specified duty cycle.

16. A filtration system which includes
a filter comprising a receptacle defining a chamber and a granular filtering medium contained in the chamber of the receptacle, the receptacle further defining an opening;
an injection pump in communication with the opening for injecting waste water to be treated into the chamber of the receptacle, the injection pump being configured to pump the water into the chamber of the receptacle at a first flow rate; and
a discharge pump also in communication with the opening for discharging water from the chamber of the receptacle, the discharge pump being configured to discharge the water from the chamber of the receptacle at a second flow rate which is lower than the first flow rate of the injection pump.

17. The system of claim 16 which includes a controller for controlling operation of at least the discharge pump to cause the discharge pump to discharge water from the receptacle in a pulsed manner with a specified duty cycle.

18. The system of claim 16 which includes a turbulence enhancing mechanism arranged downstream of the opening of the receptacle to impart turbulence to the waste water as it is injected into the chamber of the receptacle.

19. The system of claim 16 which includes an isolation valve arranged upstream of the opening to inhibit back flow of water discharged via the discharge pump into the injection pump or any components arranged upstream of the injection pump.

20. The system of claim 16 which includes additional purification components arranged downstream of the filter and a storage unit for storing further treated water output from the additional purification components, the system further including a feedback mechanism for feeding a quantity of water stored in the storage unit to flush at least the additional purification components.

21. The system of claim 20 in which the additional purification components comprise a particle filtration module arranged downstream of the filter and a sterilisation module arranged downstream of the particle filtration module, the feedback mechanism flushing at least those modules.

22. The system of claim 21 in which the feedback mechanism is configured to use a pulse of treated water stored in the storage unit to flush the particle filtration module and the sterilisation module.

23. A filtration system which includes
a filter comprising a receptacle defining a chamber and a granular filtering medium contained in the chamber of the receptacle and the receptacle further defining an opening;
an injection pump in communication with the opening for injecting waste water to be treated into the chamber of the receptacle;
a discharge pump also in communication with the opening for discharging treated waste water from the chamber of the receptacle; and
a controller for controlling operation of at least the discharge pump to cause the discharge pump to discharge water from the receptacle in a pulsed manner with a specified duty cycle.
